(19) United States
(12) Patent Application Publication
(10) Pub. No.: US 2026/0099139 A1
(43) Pub. Date: Apr. 9, 2026

(54) INFORMATION PROCESSING METHOD, INFORMATION PROCESSING DEVICE, AND PROGRAM

(71) Applicant: PANASONIC INTELLECTUAL PROPERTY MANAGEMENT CO., LTD.., Osaka (JP)

(72) Inventor: Ryosuke NAGUMO, Tokyo (JP)

(21) Appl. No.: 19/405,866

(22) Filed: Dec. 2, 2025

Related U.S. Application Data
(63) Continuation of application No. PCT/JP2024/018246, filed on May 16, 2024.

(30) Foreign Application Priority Data
Jun. 7, 2023 (JP) 2023-093803

(51) Int. Cl. G05B 23/02

(52) U.S. Cl. CPC G05B 23/0243; G05B 23/024

(57) ABSTRACT

An information processing device acquires a command signal for driving a servomotor and measurement data measured for the servomotor or a control target device, calculates abnormality degree of an operation of the servomotor based on the command signal and the measurement data by using a trained estimation model, causes a display device to display the measurement data and the abnormality degree, acquires, from an input device, region setting information indicating a range of a partial region set by a user operation from an entire region of the displayed measurement data, acquires, from the input device, attribute setting information indicating a normal or abnormal attribute set by a user operation for partial data belonging to a partial region in the displayed measurement data, and updates the estimation model based on the partial data and the attribute setting information.

### FIELD OF INVENTION

The present disclosure relates to an information processing method, an information processing device, and a program.

### BACKGROUND ART

For example, Patent Literatures 1 and 2 disclose a learning method of an estimation model used for abnormality detection of an industrial machine.

However, in Patent Literatures 1 and 2, there is no study on updating a trained estimation model by using data obtained by an operation during actual operation, and specializing the estimation model for each environment such as a manufacturing factory or a manufacturing line to improve estimation accuracy.

Patent Literature 1: JP 2020-102001 A Patent Literature 2: JP 2020-128013 A

### SUMMARY OF THE INVENTION

An object of the present disclosure is to obtain an information processing method, an information processing device, and a program that allow easy update of a trained estimation model by user operation, by which estimation accuracy of the estimation model can be improved.

An information processing method according to one aspect of the present disclosure is an information processing method for updating an estimation model for calculating abnormality degree of an operation of a servomotor that controls a control target device, the information processing method causing an information processing device to acquire a command signal for driving the servomotor and measurement data measured for the servomotor or the control target device when the servomotor performs an operation based on the command signal, calculate abnormality degree of an operation of the servomotor based on the acquired command signal and the acquired measurement data by using a trained estimation model that estimates and outputs abnormality degree based on an input command signal and input measurement data, cause a display device to display the acquired measurement data and the calculated abnormality degree, acquire, from an input device, region setting information indicating a range of a partial region set by a user operation from an entire region of the displayed measurement data, acquire, from the input device, attribute setting information indicating a normal or abnormal attribute set by a user operation for partial data belonging to the partial region in the displayed measurement data, and update the estimation model based on the partial data and the attribute setting information.

### BRIEF DESCRIPTION OF THE DRAWINGS

FIG. 1 is a diagram illustrating a simplified configuration of a state determination device according to an embodiment of the present disclosure.

FIG. 2 is a flowchart showing processing executed by an information processing unit.

FIG. 3 is a diagram illustrating an example of a screen displayed on a display device.

FIG. 4 is a diagram illustrating a setting example of an operation period.

FIG. 5 is a flowchart showing processing executed by the information processing unit.

FIG. 6 is a diagram illustrating an example of a screen displayed on the display device.

FIG. 7 is a flowchart showing processing executed by the information processing unit.

FIG. 8 is a diagram illustrating an example of a screen displayed on the display device.

FIG. 9 is a diagram illustrating an example of a screen displayed on the display device.

FIG. 10 is a flowchart showing processing executed by the information processing unit.

FIG. 11 is a diagram illustrating an example of a screen displayed on the display device.

FIG. 12 is a diagram illustrating an example of a screen displayed on the display device.

FIG. 13 is a diagram illustrating an example of a screen displayed on the display device.

FIG. 14 is a diagram illustrating an example of a screen displayed on the display device.

### DETAILED DESCRIPTION

### Findings as basis of present disclosure

For example, Patent Literatures 1 and 2 disclose a learning method of an estimation model used for abnormality detection of an industrial machine. In Patent Literature 1, an estimation model expressing a normal behavior of an industrial machine is generated by performing unsupervised learning using only normal data. In Patent Literature 2, a plurality of pieces of time-series data are created by sliding time-series data included in acquired data acquired from an industrial machine on a time axis, and machine learning is performed using a plurality of pieces of acquired data each including a plurality of pieces of time-series data, so that a general-purpose estimation model capable of supporting various industrial machines is generated.

However, in operation at the time of actual operation of an industrial machine, a generation mode and the like of normal data or abnormal data are different according to each environment such as a manufacturing factory or a manufacturing line. For this reason, accuracy is insufficient in abnormality detection using a general-purpose estimation model, and it is desired to construct a specialized estimation model according to each environment. Further, in a manufacturing line or the like that controls a control target device by a servomotor, in a case where a new operation pattern of the servomotor is added, in a case where an operation determined to be abnormal in an estimation model is analyzed and found to be normal, or the like, it is desirable to easily update the estimation model by reflecting a circumstance of each environment.

In order to solve such a problem, the present inventor has found that by causing a display device to display measurement data when a servomotor performs an operation based on a command signal and abnormality degree of operation of the servomotor calculated using an estimation model, and prompting the user to input region setting information indicating a range of a partial region to be corrected and attribute information indicating a normal or abnormal attribute with respect to the displayed measurement data, the estimation model can be easily updated by reflecting a circumstance of each environment, and has arrived at the present disclosure.

Next, each aspect of the present disclosure will be described.

An information processing method according to a first aspect of the present disclosure is an information processing method for updating an estimation model for calculating abnormality degree of an operation of a servomotor that controls a control target device, the information processing method causing an information processing device to acquire a command signal for driving the servomotor and measurement data measured for the servomotor or the control target device when the servomotor performs an operation based on the command signal, calculate abnormality degree of an operation of the servomotor based on the acquired command signal and the acquired measurement data by using a trained estimation model that estimates and outputs abnormality degree based on an input command signal and input measurement data, cause a display device to display the acquired measurement data and the calculated abnormality degree, acquire, from an input device, region setting information indicating a range of a partial region set by a user operation from an entire region of the displayed measurement data, acquire, from the input device, attribute setting information indicating a normal or abnormal attribute set by a user operation for partial data belonging to the partial region in the displayed measurement data, and update the estimation model based on the partial data and the attribute setting information.

According to the first aspect, the display device is caused to display the acquired measurement data and the calculated abnormality degree, the region setting information and the attribute setting information set by a user operation are acquired from the input device, and an estimation model is updated based on partial data and the attribute setting information. By this, a trained estimation model can be easily updated by a user operation, so that estimation accuracy of the estimation model can be improved.

In the information processing method according to a second aspect of the present disclosure, in the first aspect, in update of the estimation model, the estimation model is preferably additionally trained by use of the partial data and the attribute setting information as teaching data.

According to the second aspect, an estimation model can be appropriately updated by additional training of the estimation model using partial data and the attribute setting information as teaching data.

In the information processing method according to a third aspect of the present disclosure, in the second aspect, in update of the estimation model, in a case where an attribute of abnormality is set by a user operation for the partial data in which the calculated abnormality degree is equal to or less than a predetermined threshold, the estimation model is preferably additionally trained so that the abnormality degree exceeding the threshold is calculated for the partial data, and in a case where a normal attribute is set by a user operation for the partial data in which the calculated abnormality degree exceeds the threshold, the estimation model is preferably additionally trained such that the abnormality degree equal to or less than the threshold is calculated for the partial data.

According to the third aspect, an estimation model can be appropriately updated so that abnormal data erroneously determined to be normal is correctly determined to be abnormal and normal data erroneously determined to be abnormal is correctly determined to be normal.

The information processing method according to a fourth aspect of the present disclosure, in the second or third aspect, preferably further causes the display device to display the abnormality degree calculated using the estimation model after additional training in association with the partial data.

According to the fourth aspect, by causing the display device to display abnormality degree calculated using an estimation model after additional training, the user can confirm that the estimation model is appropriately updated, and convenience can be improved.

In the information processing method according to a fifth aspect of the present disclosure, in any one of the first to fourth aspects, an operation period of the servomotor preferably includes a plurality of operation periods including an acceleration period, a deceleration period, and a constant-speed period, and setting of the partial region and setting of the attribute by a user operation can preferably be individually executed for each operation period of a plurality of operation periods.

According to the fifth aspect, by individually setting a partial region and an attribute for each operation period of a plurality of operation periods, an estimation model can be updated in a fine-grained manner.

An information processing device according to a sixth aspect of the present disclosure is an information processing device that updates an estimation model for calculating abnormality degree of an operation of a servomotor that controls a control target device, the information processing device including a data acquisition unit that acquires a command signal for driving the servomotor and measurement data measured for the servomotor or the control target device when the servomotor performs an operation based on the command signal, a calculation unit that calculates abnormality degree of an operation of the servomotor based on the acquired command signal and the acquired measurement data by using a trained estimation model that estimates and outputs abnormality degree based on an input command signal and input measurement data, a display control unit that causes a display device to display the acquired measurement data and the calculated abnormality degree, an information acquisition unit that acquires, from an input device, region setting information indicating a range of a partial region set by a user operation from an entire region of the displayed measurement data, and attribute setting information indicating a normal or abnormal attribute set by a user operation for partial data belonging to the partial region in the displayed measurement data, and a learning unit that updates the estimation model based on the partial data and the attribute setting information.

According to the sixth aspect, the display device is caused to display the acquired measurement data and the calculated abnormality degree, the region setting information and the attribute setting information set by a user operation are acquired from the input device, and an estimation model is updated based on partial data and the attribute setting information. By this, a trained estimation model can be easily updated by a user operation, so that estimation accuracy of the estimation model can be improved.

A program according to a seventh aspect of the present disclosure is a program for causing an information processing device, which updates an estimation model for calculating abnormality degree of an operation of a servomotor that controls a control target device, to execute processing, the program causing the information processing device, when executed, to acquire a command signal for driving the servomotor and measurement data measured for the servomotor or the control target device when the servomotor performs an operation based on the command signal, calculate abnormality degree of an operation of the servomotor based on the acquired command signal and the acquired measurement data by using a trained estimation model that estimates and outputs abnormality degree based on an input command signal and input measurement data, cause a display device to display the acquired measurement data and the calculated abnormality degree, acquire, from an input device, region setting information indicating a range of a partial region set by a user operation from an entire region of the displayed measurement data, and attribute setting information indicating a normal or abnormal attribute set by a user operation for partial data belonging to the partial region in the displayed measurement data, and update the estimation model based on the partial data and the attribute setting information.

According to the seventh aspect, the display device is caused to display the acquired measurement data and the calculated abnormality degree, the region setting information and the attribute setting information set by a user operation are acquired from the input device, and an estimation model is updated based on partial data and the attribute setting information. By this, a trained estimation model can be easily updated by a user operation, so that estimation accuracy of the estimation model can be improved.

The present disclosure may also be implemented as a program for causing a computer to perform each characteristic configuration included in a method or a device as described above, or a system that operates with the program. It is needless to say that such a computer program can be distributed via a computer-readable non-transitory recording medium such as a CD-ROM or via a communication network such as the Internet.

### Embodiment of present disclosure

An embodiment of the present disclosure will be described in detail below with reference to the drawings. Elements denoted with the same reference symbol in different drawings represent the same or corresponding elements. Constituent elements, placement positions of the constituent elements, connection forms, the order of operations, and the like shown in an embodiment below are an example, and are not intended to limit the present disclosure. The present disclosure is limited only by the claims. Therefore, a constituent element that is not described in an independent claim indicating the most generic concept of the present disclosure among constituent elements in an embodiment below is not necessarily required to achieve the object of the present disclosure, but the constituent element is described as constituting a more preferable form.

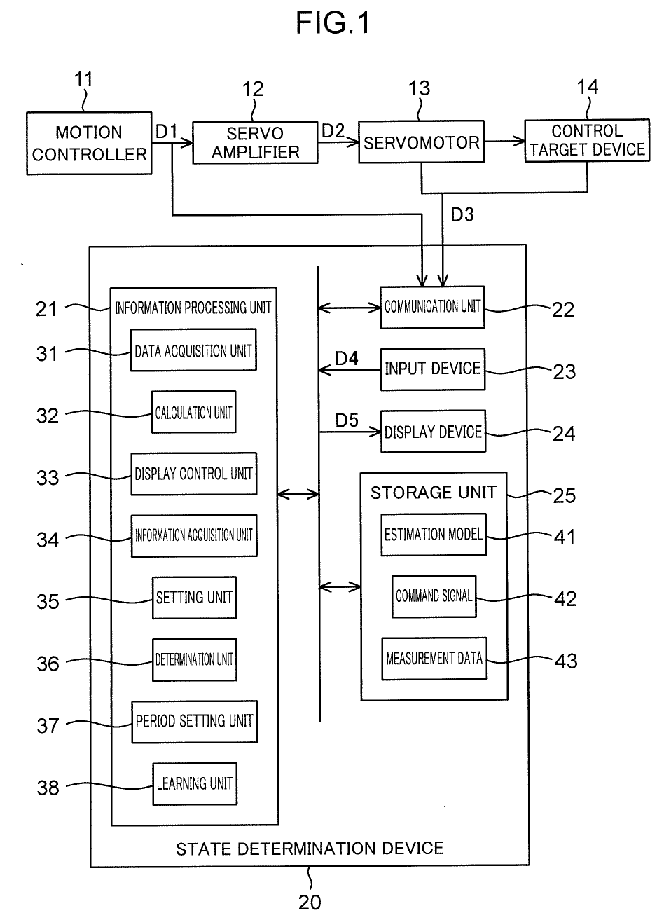

FIG. 1 is a diagram illustrating a simplified configuration of a state determination device 20 according to an embodiment of the present disclosure. The state determination device 20 determines whether an operation of a servomotor 13 that controls a control target device 14 is normal or abnormal by using a preset threshold H. The control target device 14 is, for example, a production device used to produce equipment. The production device includes a mounting device, a processing device, a machining device, a conveyance device, or the like for mounting, processing, machining, conveying, or the like of equipment. The production device is installed, for example, in a production line of a factory. The servomotor 13 may be a rotary motor or a linear motor. The state determination device 20 may be a dedicated terminal, a general-purpose PC, or a server device. Further, a function of the state determination device 20 may be implemented in a motion controller 11.

Abnormality of the servomotor 13 includes abnormality of the control target device 14 in addition to abnormality of the servomotor 13 itself.

The motion controller 11 outputs a command signal D1. The command signal D1 includes a position command signal, a speed command signal, a torque command signal, or the like for designating a moving position, a moving speed, generated torque, or the like of the servomotor 13. A servo amplifier 12 drives the servomotor 13 based on the command signal D1 input from the motion controller 11. The command signal D1 is input to the state determination device 20. Further, measurement data D3 is input to the state determination device 20. The measurement data D3 is data measured with respect to the servomotor 13 or the control target device 14 when the servomotor 13 operates based on the command signal D1. The measurement data D3 includes, for example, position data measured by a position sensor, torque data measured by a torque sensor, temperature data measured by a temperature sensor, or current data measured by a current sensor.

The state determination device 20 includes an information processing unit 21, a communication unit 22, an input device 23, a display device 24, and a storage unit 25.

The information processing unit 21 is configured using a processor such as a CPU. The information processing unit 21 includes a data acquisition unit 31, a calculation unit 32, a display control unit 33, an information acquisition unit 34, a setting unit 35, a determination unit 36, a period setting unit 37, and a learning unit 38 as functions implemented by the processor executing a program read from a non-volatile recording medium such as a computer-readable ROM. In other words, the program is a program for causing the information processing unit 21 as an information processing device mounted in the state determination device 20 to function as the data acquisition unit 31 (data acquiring means), the calculation unit 32 (calculating means), the display control unit 33 (display controlling means), the information acquisition unit 34 (information acquiring means), the setting unit 35 (setting means), the determination unit 36 (determining means), the period setting unit 37 (period setting means), and the learning unit 38 (learning means). Details of the processing content executed by each processing unit will be described later.

The communication unit 22 includes a communication module corresponding to any communication scheme such as a dedicated line network or a public line network.

The input device 23 includes a mouse, a keyboard, a touch panel, or the like that can be operated by the user.

The display device 24 includes a liquid crystal display, an organic EL display, or the like that can be visually recognized by the user who operates the input device 23.

The storage unit 25 includes an HDD, an SSD, a semiconductor memory, or the like. The storage unit 25 holds an estimation model 41, a command signal 42, and measurement data 43. The estimation model 41 is a trained estimation model having the command signal D1 and the measurement data D3 as explanatory variables and abnormality degree of operation of the servomotor 13 as an objective variable. The estimation model 41 is trained by unsupervised learning using a large number of pieces of normal data by the learning unit 38, for example. The estimation model 41 estimates and outputs abnormality degree N by using a predetermined algorithm based on the input command signal D1 and measurement data D3. For example, the estimation model 41 estimates and outputs the abnormality degree N by using an algorithm such as a Mahalanobis distance, k-NN, a decision tree, SVM, or Naïve Bayes based on a speed command signal included in the command signal D1 and torque data included in the measurement data D3. The abnormality degree N is an index representing degree of deviation from normal data, and a value of the abnormality degree N increases as degree of deviation from normal data increases, and a value of the abnormality degree N decreases as degree of deviation from normal data decreases.

### Setting of threshold

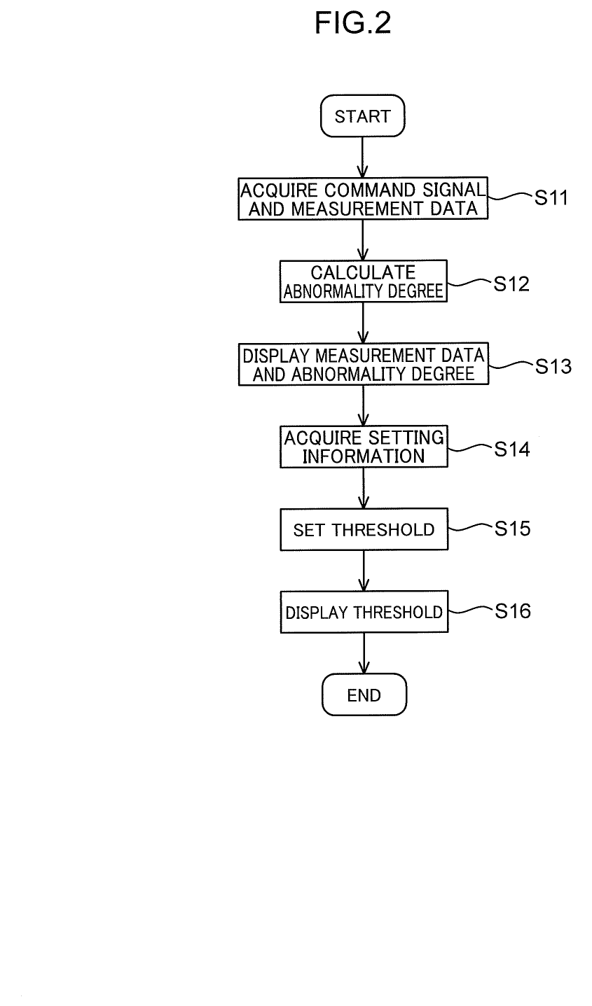

FIG. 2 is a flowchart illustrating processing executed by the information processing unit 21 regarding setting of the threshold H.

First, in Step S11, the data acquisition unit 31 acquires the command signal D1 for driving the servomotor 13 and the measurement data D3 measured for the servomotor 13 or the control target device 14 when the servomotor 13 operates based on the command signal D1. The command signal D1 and the measurement data D3 to be acquired may be the command signal D1 and the measurement data D3 corresponding to one specific operation, or may be statistical values (for example, average values) of the command signal D1 and the measurement data D3 corresponding to a plurality of past operations. The command signal D1 and the measurement data D3 corresponding to a plurality of past operations are stored in a database as the command signal 42 and the measurement data 43 in the storage unit 25.

Next, in Step S12, the calculation unit 32 inputs the command signal D1 and the measurement data D3 acquired in Step S11 to the estimation model 41, so as to calculate the abnormality degree N of operation of the servomotor 13 as output from the estimation model 41. Note that a calculation method of the abnormality degree N by the calculation unit 32 is not limited to a method using the estimation model 41, and may be a rule-based calculation method or the like.

Next, in Step S13, the display control unit 33 generates image data D5 including the measurement data D3 acquired in Step S11 and the abnormality degree N calculated in Step S12, and inputs the image data D5 to the display device 24 to cause the display device 24 to display the measurement data D3 and the abnormality degree N.

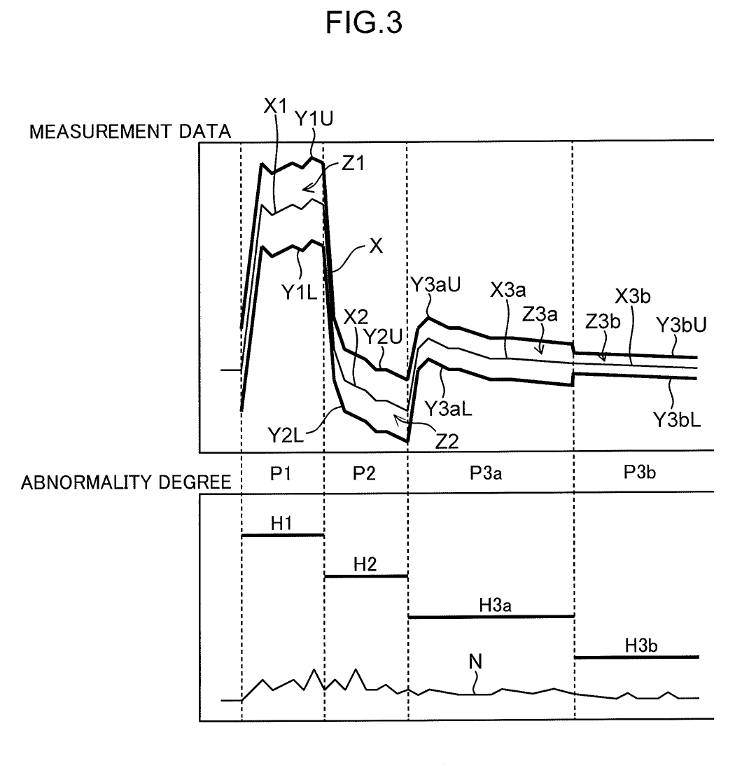

FIG. 3 is a diagram illustrating an example of a screen displayed on the display device 24 regarding setting of the threshold H. On the display device 24, a screen indicating time-series measurement data X indicated by the measurement data D3 and a screen indicating the time-series abnormality degree N corresponding to the measurement data X are arranged and displayed. For example, the horizontal axis of the screen indicating the measurement data X is time, and the vertical axis is a measurement value of torque data.

An operation period of the servomotor 13 is divided into a plurality of operation periods P including an acceleration period P1, a deceleration period P2, and a constant-speed period P3. The constant-speed period P3 is divided into a transition period P3a including an initial stage of the constant-speed period P3 and a steady period P3b including an end stage of the constant-speed period P3. The transition period P3a is a period in which a value of speed command data is zero but a measurement value of torque data or speed data is larger than a predetermined value due to inertia. The steady period P3b is a period in which a measurement value of torque data or speed data becomes equal to or less than a predetermined value. An operation period is set by the period setting unit 37. The measurement data X includes measurement data X1 belonging to the acceleration period P1, measurement data X2 belonging to the deceleration period P2, measurement data X3a belonging to the transition period P3a, and measurement data X3b belonging to the steady period P3b.

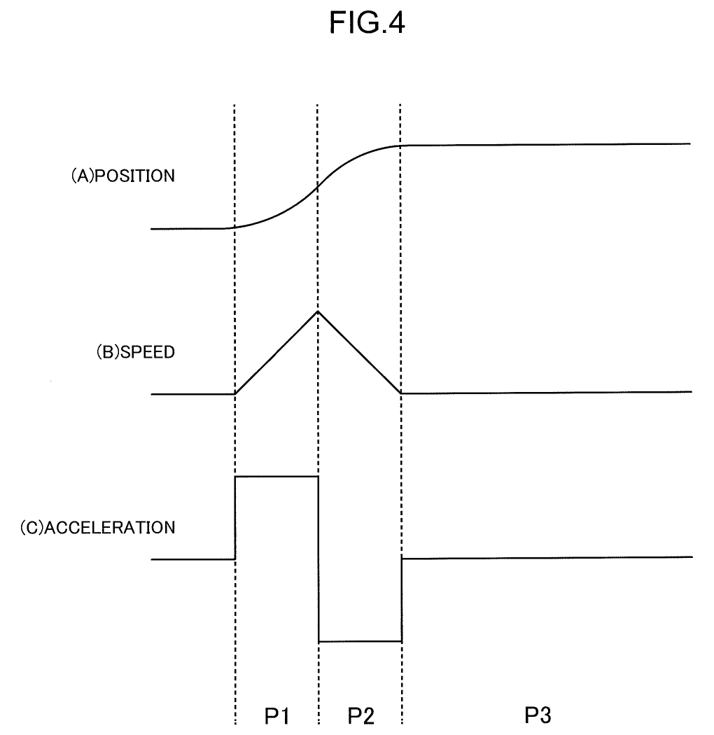

FIG. 4 is a diagram illustrating a setting example of the operation period P by the period setting unit 37. First, the period setting unit 37 acquires a position command signal included in the command signal D1 as illustrated in (A). Next, the period setting unit 37 calculates speed command data by differentiating the position command signal as illustrated in (B). Next, the period setting unit 37 calculates acceleration command data by differentiating the speed command data as illustrated in (C). The period setting unit 37 sets a period in which an absolute value of acceleration is more than or equal to a certain value and the sign is positive as the acceleration period P1. Further, the period setting unit 37 sets a period in which an absolute value of acceleration is equal to or more than a certain value and the sign is negative as the deceleration period P2. The period setting unit 37 sets a period in which an absolute value of acceleration is less than a certain value as the constant-speed period P3. Further, the period setting unit 37 sets, as the transition period P3a, a period before a lapse of predetermined time from a start time point of the constant-speed period P3, and sets, as the steady period P3b, a period after a lapse of predetermined time from the start time point of the constant-speed period P3. Note that the period setting unit 37 may set, as the transition period P3a, a period in which a measurement value of torque data is more than or equal to a predetermined value in the constant-speed period P3, and may set, as the steady period P3b, a period in which a measurement value of torque data is less than a predetermined value in the constant-speed period P3. Alternatively, the period setting unit 37 may set, as the transition period P3a, a period in which a measurement value of speed data is equal to or more than a predetermined value in the constant-speed period P3, and set, as the steady period P3b, a period in which a measurement value of speed data is less than a predetermined value in the constant-speed period P3.

Next, in Step S14, the information acquisition unit 34 acquires, from the input device 23, setting information D4 of an allowable range Z variably set by user operation with reference to the measurement data X displayed on the display device 24.

The user can set an allowable range Z1 defined by an upper limit Y1U and a lower limit Y1L with respect to the acceleration period P1 by moving the measurement data X1 in a vertical direction by, for example, a mouse drag operation. Further, the user can set an allowable range Z2 defined by an upper limit Y2U and a lower limit Y2L with respect to the deceleration period P2 by moving the measurement data X2 in the vertical direction by, for example, a mouse drag operation. Further, the user can set an allowable range Z3a defined by an upper limit Y3aU and a lower limit Y3aL with respect to the transition period P3a by moving the measurement data X3a in the vertical direction by, for example, a mouse drag operation. Further, the user can set an allowable range Z3b defined by an upper limit Y3bU and a lower limit Y3bL with respect to the steady period P3b by moving the measurement data X3b in the vertical direction by, for example, a mouse drag operation. The information acquisition unit 34 acquires the setting information D4 of the allowable ranges Z1, Z2, Z3a, and Z3b from the input device 23.

Note that the allowable range Z may be configured to be set not only by a drag operation using a mouse but also by movement of a slider bar, input of a numerical value, or the like. In the example of FIG. 3, the allowable range Z having the same width is set in an excess direction (upward direction) and a deficiency direction (downward direction) with respect to the measurement data X, but a width of the allowable range Z may be individually set in the excess direction and the deficiency direction. For example, in the acceleration period P1, the upper limit Y1U is set by dragging the measurement data X1 upward, the lower limit Y1L is set separately from the upper limit Y1U by dragging the measurement data X1 downward, and the allowable range Z1 defined by the upper limit Y1U and the lower limit Y1L is set.

Next, in Step S15, the setting unit 35 sets the threshold H for each of the operation periods P based on the setting information D4 acquired in Step S14. The setting unit 35 sets the threshold H according to a setting width of the allowable range Z. In the example of FIG. 3, the setting unit 35 sets a largest threshold H1 for the acceleration period P1 in which a setting width of the allowable range Z is the largest, and sets a next largest threshold H2 for the deceleration period P2 in which a setting width of the allowable range Z is the next largest. Further, the setting unit 35 sets a smallest threshold H3b for the steady period P3b in which a setting width of the allowable range Z is the smallest, and sets a next smallest threshold H3a for the transition period P3a in which a setting width of the allowable range Z is the next smallest.

In operation during actual operation of the servomotor 13, the calculation unit 32 calculates the abnormality degree N by using the estimation model 41 based on the command signal D1 and the measurement data D3. The determination unit 36 determines that the operation of the servomotor 13 is abnormal when the calculated abnormality degree N exceeds the threshold H, and determines that the operation of the servomotor 13 is normal when the calculated abnormality degree N is equal to or less than the threshold H.

In a case where the allowable range Z is individually set with respect to the excess direction and the deficiency direction with respect to the measurement data X, the setting unit 35 individually sets the threshold H with respect to the excess direction and the deficiency direction.

Next, in Step S16, the display control unit 33 causes the display device 24 to further display the threshold H set in Step S15 in association with the abnormality degree acquired in Step S11. In the example of FIG. 3, the thresholds H1, H2, H3a, and H3b are displayed corresponding to the abnormality degree N.

In display of the threshold H, the display control unit 33 may cause the display device 24 to display the threshold H by increasing or decreasing the threshold H in conjunction with setting of the allowable range Z by user operation. For example, in a case where the user expands a setting width of the allowable range Z1 by a mouse drag operation, the display control unit 33 increases the threshold H1 in real time according to the expansion of the setting width of the allowable range Z1, and causes the display device 24 to display the changed threshold H1. Further, for example, in a case where the user reduces a setting width of the allowable range Z2 by a mouse drag operation, the display control unit 33 reduces the threshold H2 in real time according to the reduction of the setting width of the allowable range Z2, and causes the display device 24 to display the changed threshold H2.

Further, a configuration in which the user can directly adjust the threshold H by a mouse drag operation or the like based on the threshold H displayed on the display device 24 may be employed. For example, when the user moves the threshold H1 upward by a mouse drag operation, the information acquisition unit 34 acquires adjustment information including a moving direction and a moving amount of the threshold H1 from the input device 23, and the setting unit 35 increases a set value of the threshold H1 according to a moving amount based on the adjustment information. Further, when the user moves the threshold H2 downward by a mouse drag operation, the information acquisition unit 34 acquires adjustment information including a moving direction and a moving amount of the threshold H2 from the input device 23, and the setting unit 35 decreases a set value of the threshold H2 according to a moving amount based on the adjustment information.

At this time, the display control unit 33 may cause the display device 24 to display the allowable range Z in an expanded or reduced manner in conjunction with increase or decrease of the threshold H by a user operation. For example, in a case where the user moves the threshold H1 upward by a mouse drag operation, the display control unit 33 expands a setting width of the allowable range Z1 in real time according to the increased threshold H1, and causes the display device 24 to display the expanded allowable range Z1. For example, in a case where the user moves the threshold H2 downward by a mouse drag operation, the display control unit 33 reduces a setting width of the allowable range Z2 in real time according to the reduced threshold H2, and causes the display device 24 to display the reduced allowable range Z2.

According to the present embodiment, the display control unit 33 causes the display device 24 to display the measurement data D3 and the abnormality degree N, and the information acquisition unit 34 acquires, from the input device 23, the setting information D4 of the allowable range Z variably set by a user operation with reference to the displayed measurement data D3. By this, the threshold H for the determination unit 36 to determine whether operation of the servomotor 13 is normal or abnormal can be variably set by a user operation.

Further, according to the present embodiment, the thresholds H1 to H3 are individually set for each operation period of a plurality of the operation periods P1 to P3, so that fine-grained abnormality detection can be performed.

Further, according to the present embodiment, the thresholds H3a and H3b are individually set for the transition period P3a and the steady period P3b, so that finer-grained abnormality detection can be performed.

In addition, according to the present embodiment, by individually setting the threshold H with respect to the excess direction and the deficiency direction with respect to the measurement data D3, fine-grained abnormality detection can be performed.

Further, according to the present embodiment, the threshold H is increased or decreased in conjunction with setting of the allowable range Z by user operation and displayed on the display device 24, so that convenience of the user can be improved.

Further, according to the present embodiment, in addition to setting of the allowable range Z, the threshold H can be directly adjusted by user operation, and for this reason, convenience of the user can be improved.

Further, according to the present embodiment, the allowable range Z is increased or decreased in conjunction with adjustment of the threshold H by user operation and displayed on the display device 24, so that convenience of the user can be further improved.

Further, according to the present embodiment, the calculation unit 32 can calculate the abnormality degree N with high accuracy by using the trained estimation model 41.

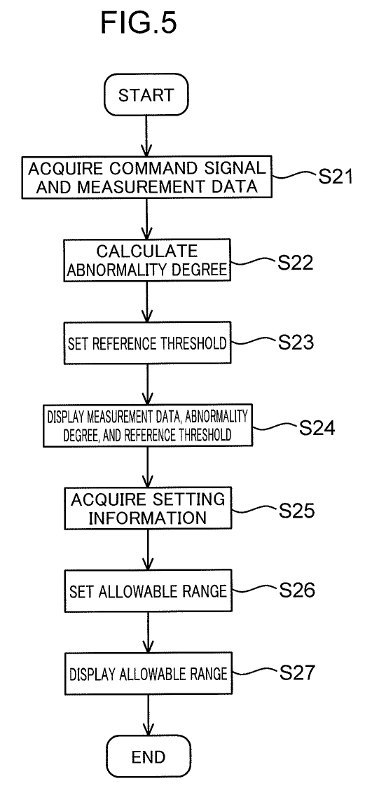

FIG. 5 is a flowchart illustrating processing executed by the information processing unit 21 regarding a variation of setting of the threshold H.

First, in Step S21, similarly to Step S11, the data acquisition unit 31 acquires the command signal D1 for driving the servomotor 13 and the measurement data D3 measured for the servomotor 13 or the control target device 14 when the servomotor 13 operates based on the command signal D1.

Next, in Step S22, similarly to Step S12, the calculation unit 32 inputs the command signal D1 and the measurement data D3 acquired in Step S21 to the estimation model 41, so as to calculate the abnormality degree N of operation of the servomotor 13 as output from the estimation model 41.

Next, in Step S23, the setting unit 35 sets a reference threshold H0 based on the command signal S1 and the measurement data D3 acquired in Step S21. For example, the setting unit 35 calculates a plurality of the abnormality degrees N in time series based on the command signal D1 and the measurement data D3, and sets a value obtained by adding k times a standard deviation σ of the abnormality degrees N to a maximum value of the abnormality degrees N as the reference threshold H0.

Next, in Step S24, the display control unit 33 inputs the generated image data D5 to the display device 24 to cause the display device 24 to display the measurement data D3, the abnormality degree N, and the reference threshold H0 in association with the abnormality degree N.

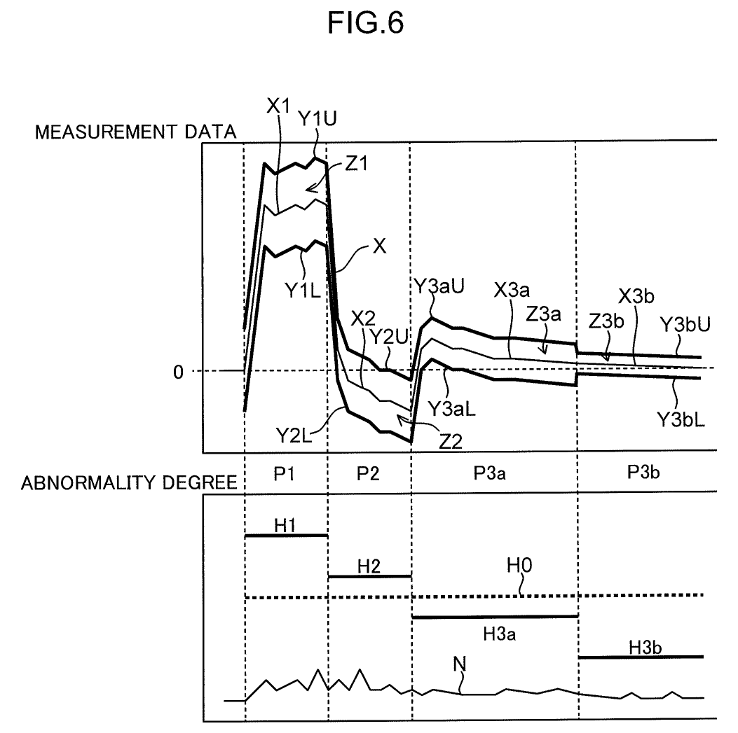

FIG. 6 is a diagram illustrating an example of a screen displayed on the display device 24. On the display device 24, a screen indicating time-series measurement data X indicated by the measurement data D3 and a screen indicating the time-series abnormality degree N corresponding to the measurement data X are arranged and displayed. Further, the reference threshold H0 is displayed in association with the abnormality degree N.

Next, in Step S25, the information acquisition unit 34 acquires, from the input device 23, the setting information D4 of the threshold H variably set by user operation with reference to the reference threshold H0 displayed on the display device 24.

For example, when the user moves the reference threshold H0 in the acceleration period P1 upward by a mouse drag operation, the information acquisition unit 34 acquires the setting information D4 including a moving direction and a moving amount of the reference threshold H0 from the input device 23. The setting unit 35 sets the threshold H1 larger than the reference threshold H0 according to the moving amount based on the setting information D4. Further, for example, when the user moves the reference threshold H0 in the transition period P3a downward by a mouse drag operation, the information acquisition unit 34 acquires the setting information D4 including a moving direction and a moving amount of the reference threshold H0 from the input device 23. The setting unit 35 sets the threshold H3a smaller than the reference threshold H0 according to the moving amount based on the setting information D4.

Next, in Step S26, the setting unit 35 sets the allowable range Z of the measurement data X based on the threshold H set for each of the operation periods P.

Next, in Step S27, the display control unit 33 causes the display device 27 to further display the allowable range Z set in Step S26 in association with the measurement data X.

At this time, the display control unit 33 may cause the display device 24 to display the allowable range Z in an expanded or reduced manner in conjunction with a movement of the reference threshold H0 by a user operation. For example, in a case where the user moves the reference threshold H0 in the acceleration period P1 upward by a mouse drag operation, the display control unit 33 expands a setting width of the allowable range Z1 in real time according to the increased threshold H1, and causes the display device 24 to display the expanded allowable range Z1. For example, in a case where the user moves the reference threshold H0 in the transition period P3a downward by a mouse drag operation, the display control unit 33 reduces a setting width of the allowable range Z3a in real time according to the reduced threshold H3a, and causes the display device 24 to display the reduced allowable range Z3a.

According to the present variation, the display control unit 33 causes the display device 24 to display the measurement data X, the abnormality degree N, and the reference threshold H0, and the information acquisition unit 34 acquires, from the input device 23, the setting information D4 of the threshold H variably set by a user operation with reference to the reference threshold H0 displayed on the display device 24. By this, the threshold H for determining whether operation of the servomotor 13 is normal or abnormal can be variably set by a user operation.

Further, according to the present variation, the allowable range Z is increased or decreased in conjunction with setting of the threshold H by the user operation and displayed on the display device 24, so that convenience of the user can be improved.

### Abnormality detection in operation during actual operation

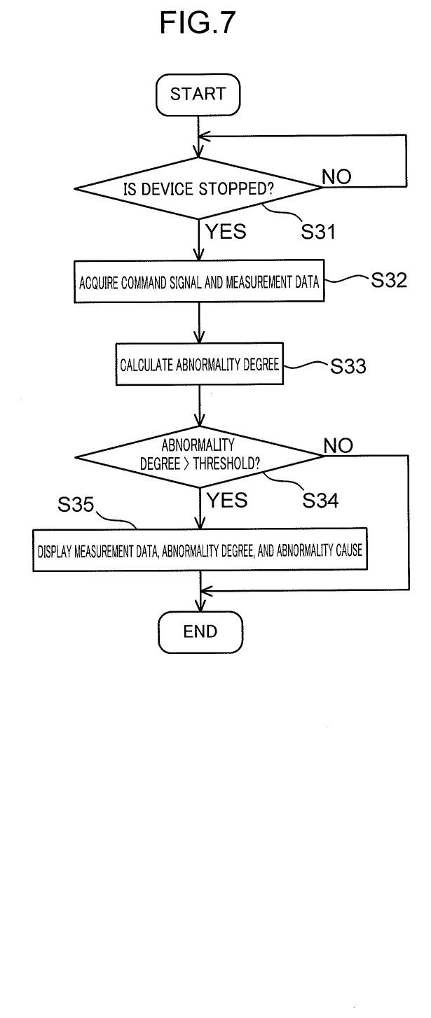

FIG. 7 is a flowchart illustrating processing executed by the information processing unit 21 regarding abnormality detection in operation during actual operation of the servomotor 13.

First, in Step S31, the determination unit 36 determines whether or not operation of the control target device 14 is forcibly stopped due to occurrence of a trouble or the like.

In a case where the control target device 14 is not forcibly stopped (Step S31: NO), the processing of Step S31 is repeatedly executed.

In a case where the control target device 14 is forcibly stopped (Step S31: YES), next in Step S32, the data acquisition unit 31 acquires the command signal D1 for driving the servomotor 13 and the measurement data D3 measured for the servomotor 13 or the control target device 14 when the servomotor 13 operates based on the command signal D1. The command signal D1 and the measurement data D3 to be acquired may be the command signal D1 and the measurement data D3 corresponding to one operation that is forcibly stopped, or may be statistical values (for example, average values) of the command signal D1 and the measurement data D3 corresponding to a plurality of operations immediately before forcible stop. The command signal D1 and the measurement data D3 corresponding to a plurality of operations are stored in a database as the command signal 42 and the measurement data 43 in the storage unit 25. Note that the processing of Step S32 may be executed not only in a case where the control target device 14 is forcibly stopped but also in a case where an abnormality analysis mode is started by a user operation or the like.

Next, in Step S33, the calculation unit 32 inputs the command signal D1 and the measurement data D3 acquired in Step S32 to the estimation model 41, so as to calculate the abnormality degree N of operation of the servomotor 13 as output from the estimation model 41. Note that a calculation method of the abnormality degree N by the calculation unit 32 is not limited to a method using the estimation model 41, and may be a rule-based calculation method or the like.

Next, in Step S34, the determination unit 36 determines whether or not the abnormality degree N calculated in Step S32 exceeds the preset threshold H. The determination unit 36 determines that operation of the servomotor 13 is abnormal in a case where the abnormality degree N exceeds the threshold H in any of a plurality of the operation periods P, and determines that operation of the servomotor 13 is normal in a case where the abnormality degree N is equal to or less than the threshold H in all of a plurality of the operation periods P.

In a case where the abnormality degree N is equal to or less than the threshold H (Step S34: NO), the information processing unit 21 ends the processing. In this case, the display control unit 33 may cause the display device 24 to display a message prompting maintenance of the control target device 14.

In a case where the abnormality degree N exceeds the threshold H (Step S34: YES), next in Step S35, the display control unit 33 generates the image data D5 including the measurement data D3 acquired in Step S32, the abnormality degree N calculated in Step S33, and an abnormality cause of operation of the servomotor 13. The abnormality cause includes the number of times of abnormality, maximum abnormality degree, or the like. The display control unit 33 inputs the image data D5 to the display device 24 to cause the display device 24 to display these pieces of information regarding an operation determined to be abnormal.

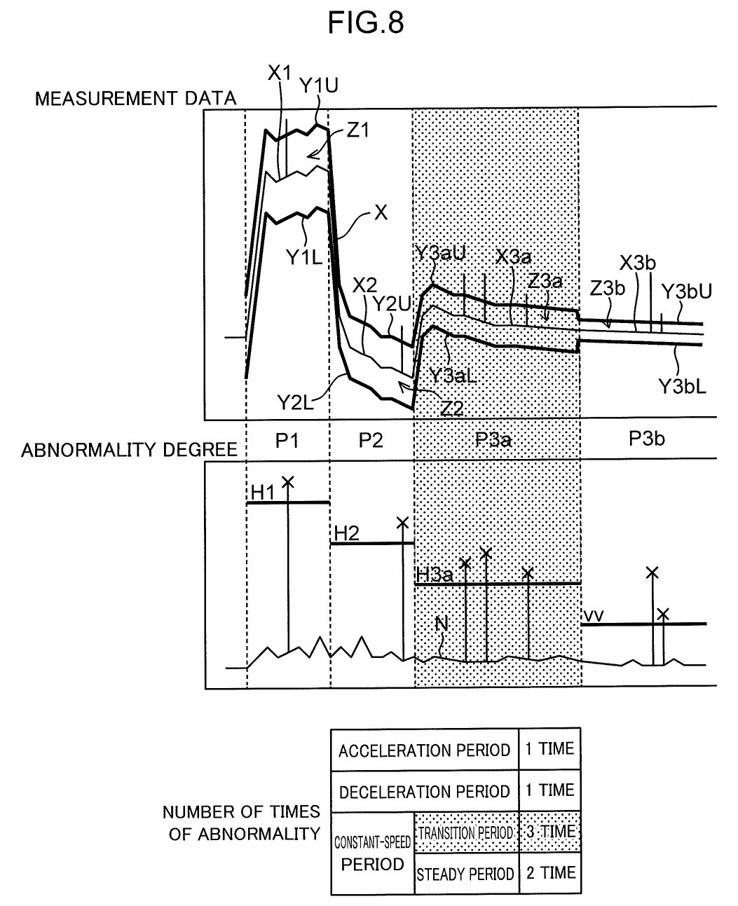

FIG. 8 is a diagram illustrating an example of a screen displayed on the display device 24 regarding abnormality detection in operation during actual operation of the servomotor 13. On the display device 24, a screen indicating the time-series measurement data X indicated by the measurement data D3, a screen indicating the time-series abnormality degree N corresponding to the measurement data X, and a screen indicating the number of times of abnormality in each of the operation periods P as an abnormality cause are arranged and displayed. The number of times of abnormality indicates the total number of times the abnormality degree N exceeds the threshold H for each of the operation periods P. In the example illustrated in FIG. 8, the number of times of abnormality is one for the acceleration period P1, one for the deceleration period P2, three for the transition period P3a, and two for the steady period P3b. Therefore, the number of times of abnormality regarding the transition period P3a is the largest.

The display control unit 33 may highlight and display, by coloring, a data portion corresponding to the operation period P (in this example, the transition period P3a) having the largest number of times of abnormality in time-series data of the measurement data X and the abnormality degree N. Further, the display control unit 33 may highlight and display, by coloring, a screen portion corresponding to the operation period P (in this example, the transition period P3a) in which the number of times of abnormality is the largest among screens indicating the number of times of abnormality. Furthermore, instead of coloring, the display control unit 33 may perform highlight display by enlarging, surrounding with a frame, or the like. By this, the user can easily recognize that an abnormality cause portion of operation of the servomotor 13 is the transition period P3a, and can use the abnormality cause portion as a clue to confirmation of actual machine operation of the servomotor 13 or the control target device 14, resetting of the threshold H, or additional training by the learning unit 38.

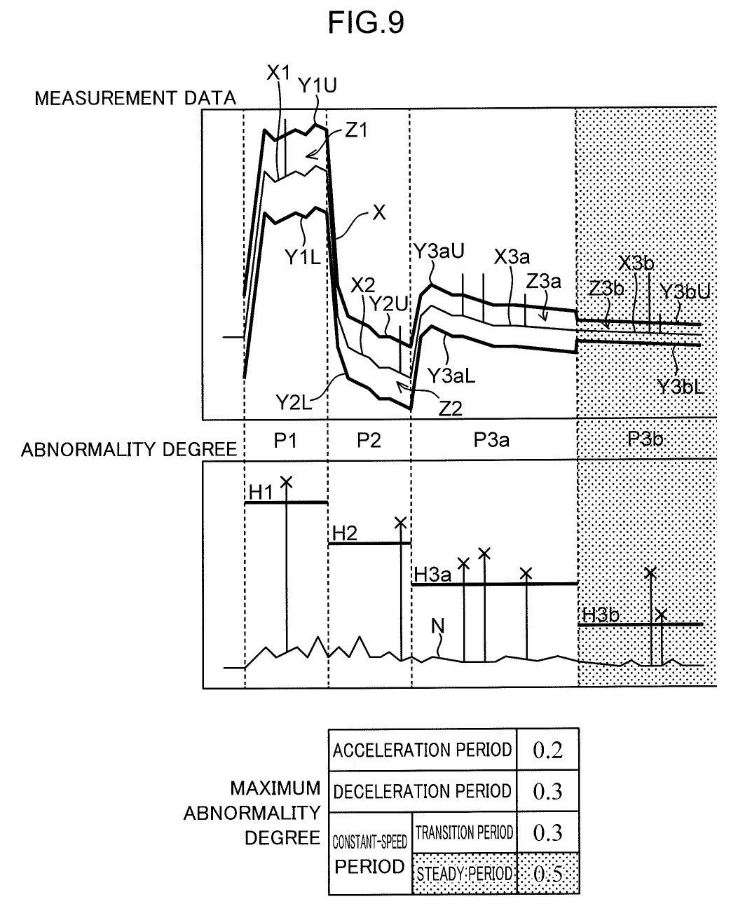

FIG. 9 is a diagram illustrating another example of a screen displayed on the display device 24 regarding abnormality detection in operation during actual operation of the servomotor 13. On the display device 24, a screen indicating the time-series measurement data X indicated by the measurement data D3, a screen indicating the time-series abnormality degree N corresponding to the measurement data X, and a screen indicating a maximum abnormality degree in each of the operation periods P as an abnormality cause are arranged and displayed. The maximum abnormality degree indicates a maximum value of the abnormality degree N for each of the operation periods P. In the example illustrated in FIG. 9, the maximum abnormality degree is 0.2 for the acceleration period P1, 0.3 for the deceleration period P2, 0.3 for the transition period P3a, and 0.5 for the steady period P3b. Therefore, the maximum abnormality degree in the steady period P3b is the highest.

The display control unit 33 may highlight and display, by coloring, a data portion corresponding to the operation period P (in this example, the steady period P3b) having the highest maximum abnormality degree in time-series data of the measurement data X and the abnormality degree N. Further, the display control unit 33 may highlight and display, by coloring, a screen portion corresponding to the operation period P (in this example, the steady period P3b) having the highest maximum abnormality degree among screens indicating the maximum abnormality degree. Furthermore, instead of coloring, the display control unit 33 may perform highlight display by enlarging, surrounding with a frame, or the like. By this, the user can easily recognize that an abnormality cause portion of operation of the servomotor 13 is the steady period P3b, and can use the abnormality cause portion as a clue to confirmation of actual machine operation of the servomotor 13 or the control target device 14, resetting of the threshold H, or additional training by the learning unit 38.

According to the present embodiment, the measurement data X and the abnormality degree N regarding operation determined to be abnormal are displayed on the display device 24, so that an abnormality cause of operation of the servomotor 13 can be appropriately presented to the user.

Further, according to the screen example illustrated in FIG. 8, the number of times of abnormality regarding each of the operation periods P is further displayed on the display device 24, so that a more detailed abnormality cause can be presented to the user.

Further, according to the screen example illustrated in FIG. 9, the maximum abnormality degree regarding each of the operation periods P is further displayed on the display device 24, so that a more detailed abnormality cause can be presented to the user.

### Update of estimation model

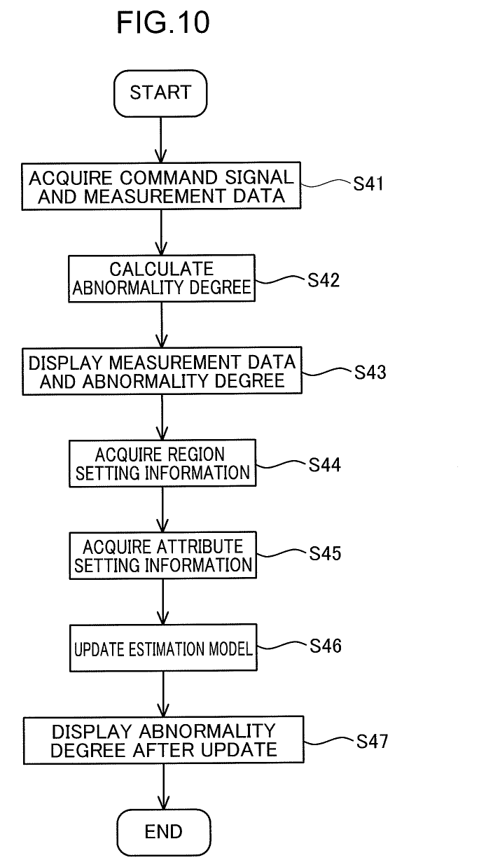

FIG. 10 is a flowchart illustrating processing executed by the information processing unit 21 regarding update of the estimation model 41.

When an update mode of the estimation model 41 is started by a user operation or the like, first, in Step S41, the data acquisition unit 31 acquires the command signal D1 for driving the servomotor 13 and the measurement data D3 measured with respect to the servomotor 13 or the control target device 14 when the servomotor 13 operates based on the command signal D1. The command signal D1 and the measurement data D3 to be acquired may be the command signal D1 and the measurement data D3 corresponding to one operation selected by a user operation or the like, or may be statistical values (for example, average values) of the command signal D1 and the measurement data D3 corresponding to a plurality of operations. The command signal D1 and the measurement data D3 corresponding to a plurality of operations are stored in a database as the command signal 42 and the measurement data 43 in the storage unit 25.

Next, in Step S42, the calculation unit 32 inputs the command signal D1 and the measurement data D3 acquired in Step S41 to the estimation model 41, so as to calculate the abnormality degree N of operation of the servomotor 13 as output from the estimation model 41.

Next, in Step S43, the display control unit 33 generates the image data D5 including the measurement data D3 acquired in Step S41 and the abnormality degree N calculated in Step S42, and inputs the image data D5 to the display device 24 to cause the display device 24 to display the measurement data D3 and the abnormality degree N.

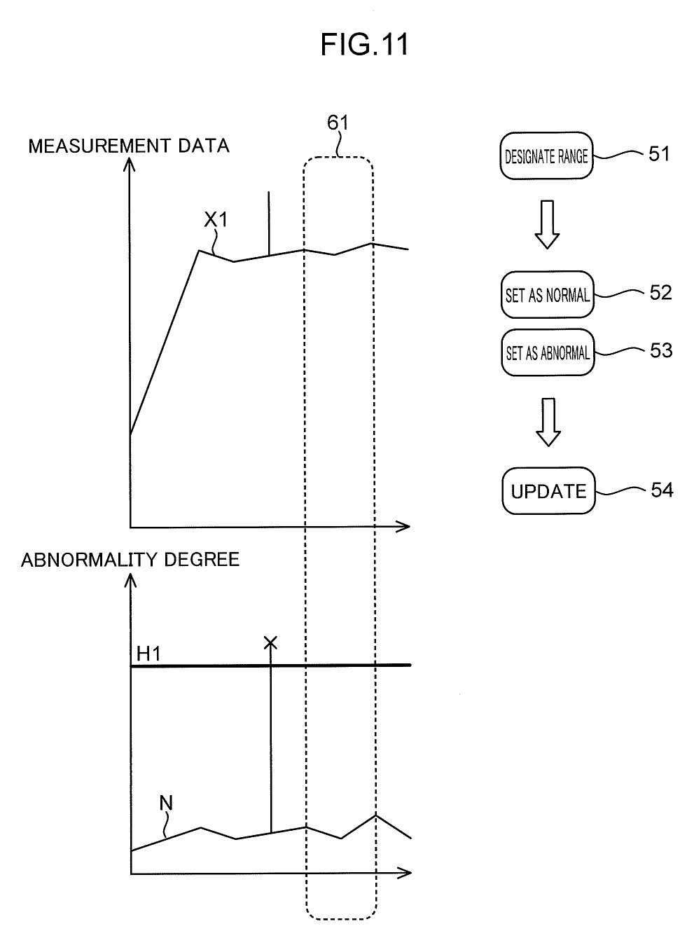

FIG. 11 is a diagram illustrating an example of a screen displayed on the display device 24 regarding update of the estimation model 41. On the display device 24, a screen indicating time-series measurement data X indicated by the measurement data D3 and a screen indicating the time-series abnormality degree N corresponding to the measurement data X are arranged and displayed. For example, the horizontal axis of the screen indicating the measurement data X is time, and the vertical axis is a measurement value of torque data. Here, the user can individually select, by a mouse operation or the like, an operation period including an update target portion of the estimation model 41 among the acceleration period P1, the deceleration period P2, the transition period P3a, and the steady period P3b regarding the measurement data X. FIG. 11 illustrates an example in which the acceleration period P1 is selected as an operation period including an update target portion. In this case, the display device 24 arranges and displays a screen indicating the measurement data X1 belonging to the acceleration period P1 and a screen indicating the time-series abnormality degree N of a portion corresponding to the measurement data X1. The threshold H1 set for the acceleration period P1 is also displayed on the screen indicating the abnormality degree N. Further, on the display device 24, an icon 51 labeled as “designate range”, an icon 52 labeled as “set as normal”, an icon 53 labeled as “set as abnormal”, and an icon 54 labeled as “update” are also displayed.

Next, in Step S44, the information acquisition unit 34 acquires, from the input device 23, the setting information D4 (region setting information) indicating a range of a partial region 61 set by a user operation from the entire region of the measurement data X1 displayed on the display device 24.

The user can arbitrarily set the partial region 61 including partial data of an update target portion in the measurement data X1, for example, by moving a mouse cursor in the up, down, left, and right directions by a mouse drag operation. Further, the user can confirm setting of the partial region 61 by clicking the icon 51 by a mouse operation, for example, after setting the partial region 61. The information acquisition unit 34 acquires, from the input device 23, the setting information D4 of the confirmed partial region 61.

Next, in Step S45, the information acquisition unit 34 acquires, from the input device 23, the setting information D4 (attribute setting information) indicating a normal or abnormal attribute set by a user operation for partial data belonging to the partial region 61 in the measurement data X1 displayed on the display device 24.

The user can set partial data belonging to the partial region 61 as normal data by clicking the icon 52 by a mouse operation, for example. In this case, the learning unit 38 assigns a label indicating “normal” to the partial data belonging to the partial region 61. On the other hand, the user can set partial data belonging to the partial region 61 as abnormal data by clicking the icon 53 by a mouse operation, for example. In this case, the learning unit 38 assigns a label indicating “abnormal” to the partial data belonging to the partial region 61.

When the user clicks the icon 54 by a mouse operation, for example, the information acquisition unit 34 acquires information to that effect from the input device 23. Next, in Step S46, based on the region setting information acquired in Step S44 and the attribute setting information acquired in Step S45, the learning unit 38 performs additional training of the estimation model 41 by supervised learning using, as teaching data, partial data belonging to the partial region 61 in the measurement data X1 and label information indicating “normal” or “abnormal”. In a case where an attribute of “abnormal” is set by a user operation for partial data in which the abnormality degree N calculated using the estimation model 41 before update is equal to or less than the threshold H1, the learning unit 38 performs additional training of the estimation model 41 so that the abnormality degree N exceeding the threshold H1 is calculated for the partial data. On the other hand, in a case where an attribute of “normal” is set by a user operation for partial data in which the abnormality degree N calculated using the estimation model 41 before update exceeds the threshold H1, the learning unit 38 performs additional training of the estimation model 41 so that the abnormality degree N equal to or less than the threshold H1 is calculated for the partial data. For the additional training, an algorithm such as a Mahalanobis distance, k-NN, a decision tree, SVM, or Naïve Bayes can be used similarly to the above. By this, the estimation model 41 stored in the storage unit 25 is updated.

Next, in Step S47, the calculation unit 32 inputs the command signal D1 and the measurement data D3 acquired in Step S41 to the estimation model 41, so as to calculate the abnormality degree N of operation of the servomotor 13 as output from the estimation model 41 after update. The display control unit 33 generates the image data D5 including the abnormality degree N calculated using the estimation model 41 after update, and inputs the image data D5 to the display device 24, so as to cause the display device 24 to display the measurement data X1 and the abnormality degree N after update.

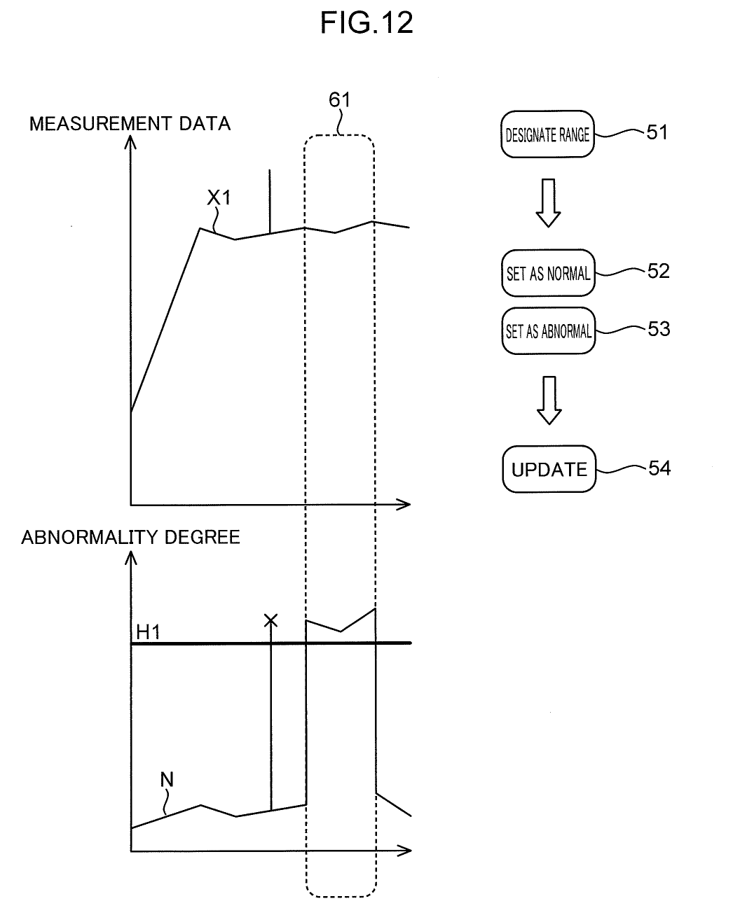

FIG. 12 is a diagram illustrating an example of a screen displayed on the display device 24 after the estimation model 41 is updated. FIG. 12 illustrates an example of a case where partial data determined to be normal data in the estimation model 41 before update is set as abnormal data by the user. The abnormality degree N corresponding to partial data included in the partial region 61 is equal to or less than the threshold H1 before update of the estimation model 41 (FIG. 11), but exceeds the threshold H1 after update of the estimation model 41 (FIG. 12).

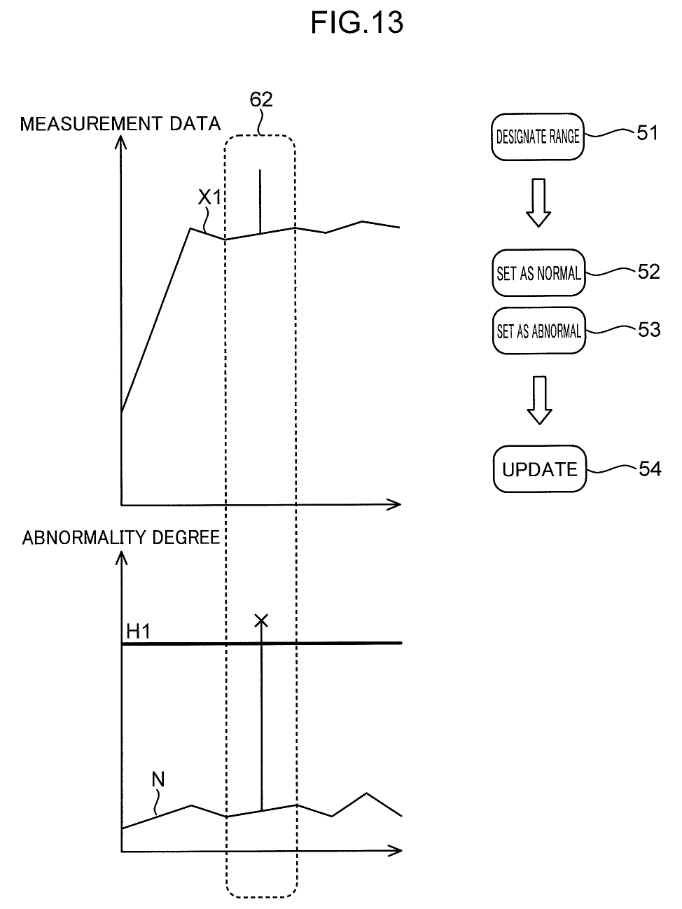

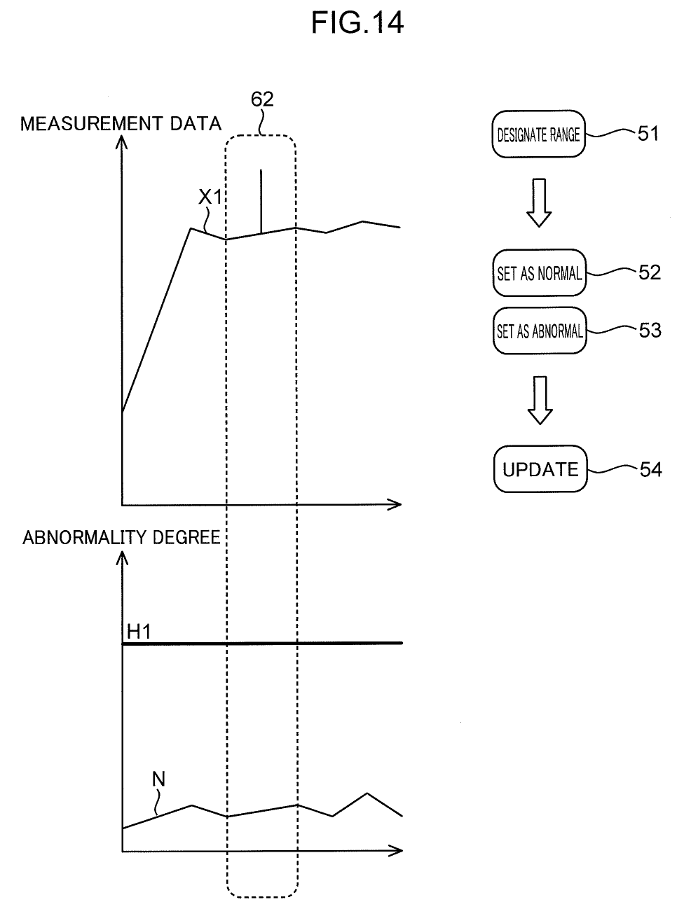

FIG. 13 is a diagram illustrating an example of a screen displayed on the display device 24 before update of the estimation model 41, and FIG. 14 is a diagram illustrating an example of a screen displayed on the display device 24 after update of the estimation model 41. FIGS. 13 and 14 illustrate an example in which partial data determined to be abnormal data in the estimation model 41 before update is set as normal data by the user. The abnormality degree N corresponding to partial data included in the partial region 62 exceeds the threshold H1 before update of the estimation model 41 (FIG. 13), but is equal to or less than the threshold H1 after update of the estimation model 41 (FIG. 14).

According to the present embodiment, the display control unit 33 causes the display device 24 to display the acquired measurement data D3 and the calculated abnormality degree N, the information acquisition unit 34 acquires the region setting information and the attribute setting information set by a user operation from the input device 23, and the learning unit 38 updates the estimation model 41 based on the partial data and the attribute setting information. By this, the trained estimation model 41 can be easily updated by a user operation, so that estimation accuracy of the estimation model 41 can be improved.

Further, according to the present embodiment, the learning unit 38 can appropriately update the estimation model 41 by additional training of the estimation model 41 using partial data and the attribute setting information as teaching data.

Further, according to the present embodiment, the learning unit 38 can appropriately update the estimation model 41 so that abnormal data erroneously determined to be normal is correctly determined to be abnormal and normal data erroneously determined to be abnormal is correctly determined to be normal.

Further, according to the present embodiment, by causing the display device 24 to display the abnormality degree N calculated using the estimation model 41 after additional training, the user can confirm that the estimation model 41 is appropriately updated, and convenience can be improved.

Further, according to the present embodiment, the estimation model 41 can be updated in a fine-grained manner by individual setting of the partial regions 61 and 62 and an attribute for each of the operation periods P of a plurality of the operation periods P.

The present disclosure is widely applicable to an abnormality detection system of a servomotor.

1. An information processing method for updating an estimation model for calculating abnormality degree of an operation of a servomotor that controls a control target device, the information processing method causing an information processing device to:
acquire a command signal for driving the servomotor and measurement data measured for the servomotor or the control target device when the servomotor performs an operation based on the command signal;
calculate abnormality degree of an operation of the servomotor based on the acquired command signal and the acquired measurement data by using a trained estimation model that estimates and outputs abnormality degree based on an input command signal and input measurement data;
cause a display device to display the acquired measurement data and the calculated abnormality degree;
acquire, from an input device, region setting information indicating a range of a partial region set by a user operation from an entire region of the displayed measurement data;
acquire, from the input device, attribute setting information indicating a normal or abnormal attribute set by a user operation for partial data belonging to the partial region in the displayed measurement data; and
update the estimation model based on the partial data and the attribute setting information.

2. The information processing method according to claim 1, wherein in update of the estimation model, the estimation model is additionally trained by use of the partial data and the attribute setting information as teaching data.

3. The information processing method according to claim 2, wherein
in update of the estimation model,
in a case where an attribute of abnormality is set by a user operation for the partial data in which the calculated abnormality degree is equal to or less than a predetermined threshold, the estimation model is additionally trained so that the abnormality degree exceeding the threshold is calculated for the partial data, and
in a case where a normal attribute is set by a user operation for the partial data in which the calculated abnormality degree exceeds the threshold, the estimation model is additionally trained such that the abnormality degree equal to or less than the threshold is calculated for the partial data.

4. The information processing method according to claim 2, further comprising causing the display device to display the abnormality degree calculated using the estimation model after additional training in association with the partial data.

5. The information processing method according to claim 1, wherein
an operation period of the servomotor includes a plurality of operation periods including an acceleration period, a deceleration period, and a constant-speed period, and
setting of the partial region and setting of the attribute by a user operation can be individually executed for each operation period of a plurality of operation periods.

6. An information processing device that updates an estimation model for calculating abnormality degree of an operation of a servomotor that controls a control target device, the information processing device comprising:
a data acquisition unit that acquires a command signal for driving the servomotor and measurement data measured for the servomotor or the control target device when the servomotor performs an operation based on the command signal;
a calculation unit that calculates abnormality degree of an operation of the servomotor based on the acquired command signal and the acquired measurement data by using a trained estimation model that estimates and outputs abnormality degree based on an input command signal and input measurement data;
a display control unit that causes a display device to display the acquired measurement data and the calculated abnormality degree;
an information acquisition unit that acquires, from an input device, region setting information indicating a range of a partial region set by a user operation from an entire region of the displayed measurement data, and attribute setting information indicating a normal or abnormal attribute set by a user operation for partial data belonging to the partial region in the displayed measurement data; and
a learning unit that updates the estimation model based on the partial data and the attribute setting information.

7. A computer-readable non-transitory recording medium recording a program for causing an information processing device, which updates an estimation model for calculating abnormality degree of an operation of a servomotor that controls a control target device, to execute processing, the program causing the information processing device, when executed, to:
acquire a command signal for driving the servomotor and measurement data measured for the servomotor or the control target device when the servomotor performs an operation based on the command signal;
calculate abnormality degree of an operation of the servomotor based on the acquired command signal and the acquired measurement data by using a trained estimation model that estimates and outputs abnormality degree based on an input command signal and input measurement data;
cause a display device to display the acquired measurement data and the calculated abnormality degree;
acquire, from an input device, region setting information indicating a range of a partial region set by a user operation from an entire region of the displayed measurement data, and attribute setting information indicating a normal or abnormal attribute set by a user operation for partial data belonging to the partial region in the displayed measurement data; and
update the estimation model based on the partial data and the attribute setting information.
